(19) United States
(12) Patent Application Publication
(10) Pub. No.: US 2020/0008579 A1
(43) Pub. Date: Jan. 9, 2020

(54) WALL FOR A FURNITURE CARCASS, METHOD FOR PRODUCING SUCH A WALL, AND FURNITURE CARCASS COMPRISING SUCH A WALL

(71) Applicant: AMBIGENCE GMBH & CO. KG, Herford (DE)

(72) Inventors: Uwe SOBOLEWSKI, Bünde (DE); Michael TASCHE, Bielefeld (DE); Stefan ANDSCHUS, Lübbecke (DE); Michael SCHUBERT, Coburg (DE)

(73) Assignee: Ambigence GmbH & Co. KG, Herford (DE)

(21) Appl. No.: 16/489,167

(22) PCT Filed: Feb. 23, 2018
(86) PCT No.: PCT/EP2018/054536

§ 371 Date: Aug. 27, 2019

(30) Foreign Application Priority Data
Feb. 28, 2017 (DE) 10 2017 104 171.0

(51) Int. Cl. A47B 96/20; E05D 3/06; A47B 96/04

(52) U.S. Cl. CPC A47B 96/205; E05Y 2900/20; A47B 96/04; E05D 3/06

(57) ABSTRACT

A wall for a furniture carcass, having a core and a housing arranged beside the core. The housing is open toward at least one end of the wall and which is used to accommodate a fitting that guides the movable furniture part. The core and the housing are covered on at least one side surface of the wall by a continuous cover layer.

### BACKGROUND AND SUMMARY OF THE INVENTION

Exemplary embodiments of the invention relate to a wall for a furniture body, which has a core and a housing arranged next to it, which is open towards at least one end face of the wall and which serves to accommodate a fitting which guides a movable part of the furniture. The invention also relates to a method for manufacturing a wall for a furniture body and a piece of furniture or furniture body with at least one such wall.

Furniture, in particular kitchen furniture such as base units or wall units, generally have a furniture body open towards the front, on which movable furniture parts guided by fittings are mounted. The movably guided furniture parts can be drawers with a drawer front or doors or flaps, which can be used individually or in different combinations in a furniture body. The present application relates in particular to the use of doors and flaps as movable furniture components. For the purposes of this application, doors and flaps are distinguished by the orientation of their pivot axis, which is vertical for doors and horizontal for flaps.

The doors and flaps can be integral or consist of several individual parts, such as a folding flap in which different parts of the flap move relative to each other in the movement sequence.

Door hinges are usually used to guide doors, which are arranged on the side of the pivot axis between the furniture body and the door. A comparable arrangement of hinges can also principally be used for flaps. These hinges are then arranged along an upper side edge of the flap. However, it is often desired to open the flaps in a combined pivoting and sliding movement in order, for example in the case of a wall cabinet, to obtain the greatest possible access to the interior of the cabinet without having to pivot the flap into a horizontal position in which it is difficult or impossible for the user to reach it to close. For this reason, special flap fittings have become established that are not arranged along the pivot axis between the furniture body and the flap, but on the side edges (usually both) between the flap and the side wall of the furniture body.

Such door hinges or flap fittings are well known for mounting on the inside of the side wall or side walls of the furniture body. However, the fittings inevitably protrude into the interior of the furniture body, which on the one hand reduces the usable storage space within the furniture body and on the other hand also impairs the structuring of the interior of the furniture body. The mounted fittings also make it difficult to clean the interior, especially the inside of the side wall of the furniture body. Last but not least, a side wall on which no fittings are mounted is desirable for optical reasons.

For the assembly of door hinges it is known to mill a pocket into the end face of a side wall in which the door hinge can be inserted from the front. In this way, the inside of the side wall remains free. A hinge suitable for use in such a milled pocket is known from the publication DE 1 559 963 A, for example.

However, this procedure is only suitable for door hinges with a very low installation depth. This is due to the limited milling depth with which such a pocket can be economically milled from the end face into the side wall during the manufacturing process. The installation thickness of the door hinge inserted in such a milled pocket is also very limited, as the side walls in the furniture area only have a wall thickness of about 16-20 mm (millimeters). During the milling process, a certain minimum wall thickness must remain on the side of the milled pockets, since a wall that is too thin would tear or break during the milling process or would be deformed in such a way that it no longer has a perfect surface.

Even the use of larger and more complex door hinges is not possible in this way. Flap hinges usually have a large installation depth of more than 10 or 15 cm (centimeters), which cannot be achieved by milling from the end face.

Publication DE 20 2013 003 189 U1 discloses a side wall for a furniture body that is made of different parts in sections. In particular, a rear part facing away from the furniture front is conventionally designed, e.g. by a coated wooden element. A front part of the side wall is formed by a housing, not described in detail in the above publication, which has a front opening into which a fitting can be inserted. The housing is connected to the conventional part of the side wall, e.g., via dowels or screws. Since the housing can be provided with thinner housing walls than is possible by milling and also allows larger installation depths, this housing can also be used to accommodate larger door hinges or a flap fitting. However, the surface appearance and haptics of the housing will generally not correspond exactly to those of the conventional part of the side wall, so that a uniform surface of the side wall cannot be achieved. In addition, a transition between the two housing parts will be visible and optionally also perceptible.

Publication DE 10 2015 108 694 A1 describes a furniture body with a flap that pivots upwards and is guided by hinges arranged along the upper side edge of the flap. A support device for the flap is also provided to support the weight of the flap when (partially) open. The support device is inserted into a housing formed as a profile that forms a front part of the side wall. The profile extends over the entire height of the side wall. Sliding guides for glide shoes, which are part of the weight compensation, are formed inside the profile. The profile is connected to the core of the side wall, which is made of a wood-based material, at the front side of the side wall by means of a tongue-and-groove joint and adhesives. On the outside, the side wall in the area of the core is provided with a uniform cover layer. A cover layer is also applied to the core of the interior of the furniture body. The fitting system shown here is therefore a normal side wall on which the joiner has to mill a groove at the front to mount the weight compensation on the side wall.

A uniform surface look and feel is not achieved because the fitting on the side wall forms an annoying visible surface. In addition, the design possibilities of the interior space are limited.

Exemplary embodiments of the present invention are directed to a wall and a method for producing a wall for a furniture body and a piece of furniture or furniture body with a wall, wherein the wall is also able to accommodate larger fittings, in particular flap fittings, but also door hinges with a larger installation depth, and the wall is characterized by a uniform surface quality on both its outside and inside.

A wall according to the invention and of the type mentioned at the beginning is characterized in that the core and the housing are covered by a continuous cover layer on at least one side surface of the wall.

A method according to the invention for the manufacture of such a wall for a furniture body comprises the following steps. A panel-shaped core and a housing for accommodating a fitting or a housing with a fitting arranged therein are provided. The core and the housing are each connected along one of their end faces and two lateral cover layers are applied to the arrangement of core and housing.

The wall according to the invention is thus a composite element consisting of a core, a housing and cover layers, wherein the housing used to accommodate the fitting is, according to the invention, already inserted during the manufacture of the wall before the cover layers are applied. Thus, there are no restrictions for the size of the housing, as is the case with the incorporation of a housing for the fitting on a wall already provided with cover layers. This means that large fittings can also be used which, for example, take up the entire or nearly the entire width of the wall in their depth. At the same time, the wall has a preferably integral, continuous cover layer on both sides.

The fitting can be inserted into the housing before the cover layers are applied or only inserted into the housing after the cover layers have been applied.

In an advantageous embodiment of the wall, the core and the housing are covered on both sides by a continuous cover layer, whereby a uniform appearance without offset steps is achieved.

In a further advantageous embodiment of the wall, the core and the housing each lie against each other at one end face, which extends over at least part of the extension of the wall. Preferably, the core and the housing are connected to each other at the adjoining end faces, for which purpose at least one fastening means engaging in at least one corresponding receptacle is preferably used. It is also possible in alternative embodiments to connect the core and the housing along several adjacent end faces.

The at least one fastening means and the at least one receptacle can form a tongue-and-groove joint, in particular a dovetail joint. Alternatively, several fastening means and receptacles can be provided, such as connecting pins and bores. The fastening means can preferably be molded onto the housing so that they do not have to be arranged with additional effort in the assembly process. For example, the connection pins mentioned can be formed onto the housing and the bores can be formed in the core. Various fastening means can also be combined, for example a tongue-and-groove joint along a first side of the joint and a joint with connecting pins on a second angled side of the joint.

Alternatively or additionally, the core and/or housing can be glued to the cover layers to form a stable bond.

In a further advantageous embodiment of the wall, the housing has connecting elements to fasten an inserted fitting in the housing. The connecting elements can include an insertion profile so that the fitting can be easily inserted into the housing before or after completion of the wall and also fastened there. For example, latching means can be provided for fastening.

In another advantageous embodiment of the wall, the housing has side plates that lie against the cover layers. The side plates are preferably dimensionally stable and especially designed to absorb lateral compressive forces. Such compressive forces are exerted, for example, when the cover layers are laminated on. The dimensional stability of the housing prevents compression during lamination. Furthermore, a fitting (already inserted) may have additional stabilizing elements to absorb lateral compressive forces.

Preferably the side plates have a distance corresponding to the thickness of the core so that no step can be seen in the cover layers.

In another advantageous embodiment of the wall, the fitting features a lever mechanism that guides the movable part of the furniture. When the movable part of the furniture is closed, the lever mechanism is preferably located between the cover layers. The fitting is then so completely integrated into the furniture body that—unavoidably—only the lever mechanism is visible, and even this only when the movable part of the furniture is open.

In a further advantageous embodiment of the wall, at least one edge band is applied to at least one of the end faces of the core and the housing. In the area of the front end face of the core and the housing, the edge band is preferably applied only when the housing is integrated or inserted, wherein the edge band is arranged at least in sections on the housing. In this way, for example, the edges of the side plates of the housing can be covered. In another alternative, at least one edge band is applied if a fitting is already arranged in the housing and the wall. In this case, the edge band can also cover edges of side plates of the fitting.

A piece of furniture or furniture body according to the invention has at least one such wall manufactured in accordance with a method described above. This leads to the advantages described in connection with the wall or the method.

In an advantageous embodiment of the piece of furniture or the furniture body, the at least one wall is a side wall and/or a partition wall with a housing, wherein a fitting is inserted into the housing. The fitting can be a flap fitting or a door fitting.

In the context of the application, the wall according to the invention may be arranged on either side of the furniture body, irrespective of its orientation. In particular, the wall can be arranged in any orientation within the furniture body, especially vertically, horizontally or diagonally, for example diagonally in the furniture body.

### BRIEF DESCRIPTION OF THE DRAWING FIGURES

The invention will be explained in more detail in the following by means of embodiment examples shown in the figures, wherein:

FIG. 1 shows a first embodiment example of a piece of furniture with a wall according to the application;

FIGS. 2a, 2b show a second embodiment example of a piece of furniture having a wall according to the application in two different opening positions of a flap;

FIGS. 3a, 3b show a third embodiment example of a piece of furniture having a wall according to the application in two different opening positions of a flap;

FIG. 4 shows a fourth embodiment example of a piece of furniture having a wall according to the application;

FIGS. 5, 6 each show an embodiment example of a wall according to application for a furniture body in an isometric exploded view;

FIG. 7, 8 each show an embodiment example of a partially assembled furniture body having a fitting to be inserted in an isometric view; and

FIG. 9 shows a schematic top view of a front end face of a wall for a furniture body in the area of an inserted fitting.

### DETAILED DESCRIPTION

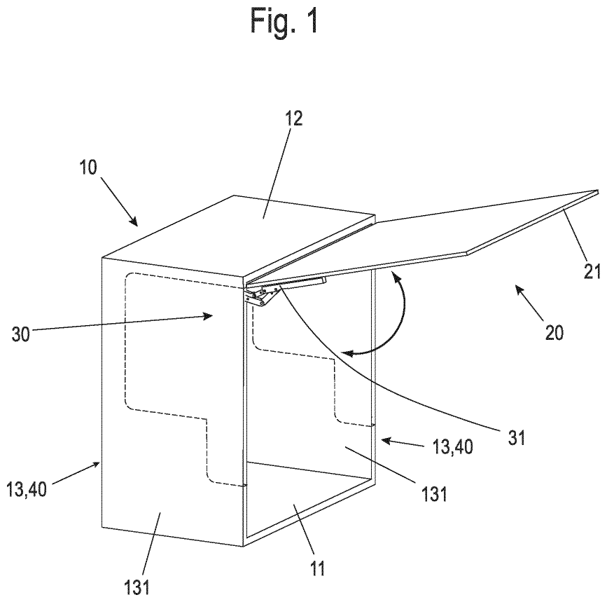

FIG. 1 shows in an isometric representation a wall unit of a kitchen, for example, as the first embodiment example of a piece of furniture with a (side) wall according to the application.

The wall unit comprises a furniture body 10 with a bottom panel 11 and top panel 12 as well as two side walls 13. A rear wall is preferred for reasons of stability but is not shown in this embodiment example.

The furniture body 10 is open to the front to allow access to the interior of the cupboard. A flap arrangement 20 with an integral flap 21 is provided to close the opening of the furniture body 10. The integral flap 21 is pivotably mounted along its upper horizontal side edge. For this purpose, fittings 30 are provided which are connected to the integral flap 21 with a lever mechanism 31 in the upper part of the flap 21.

The fittings 30 (with the exception of the lever mechanism 31 extended in the opening position shown) are arranged within the respective side wall 13. When flap 21 is closed, the lever mechanism 31 may be fully retracted into the side wall 13, optionally except for the mounting elements for connecting it to flap 21. The area within the side wall 13 in which the fitting 30 is located is indicated by a dashed line in FIG. 1.

The side wall 13 is characterized by side surfaces 131, which are ideally integral and can have the same surface texture throughout the entire surface. The surface of the integral side surfaces 131 can create design effects through different patterns, surface textures or different colors. This preferably applies both to an outer one of the side surfaces 131 and to an inner one of the side surfaces 131 facing the interior of the furniture body 10. The side walls 13 also have an end face 132, which has an opening 133 in the area of the fitting 30, into which the lever mechanism 31 of the fitting 30 dips or from which the lever mechanism 31 extends. When the flap arrangement 20 is closed, the lever mechanism 31 is completely immersed in the opening 133, except for any fastening means with which it is connected to the integral flap 21.

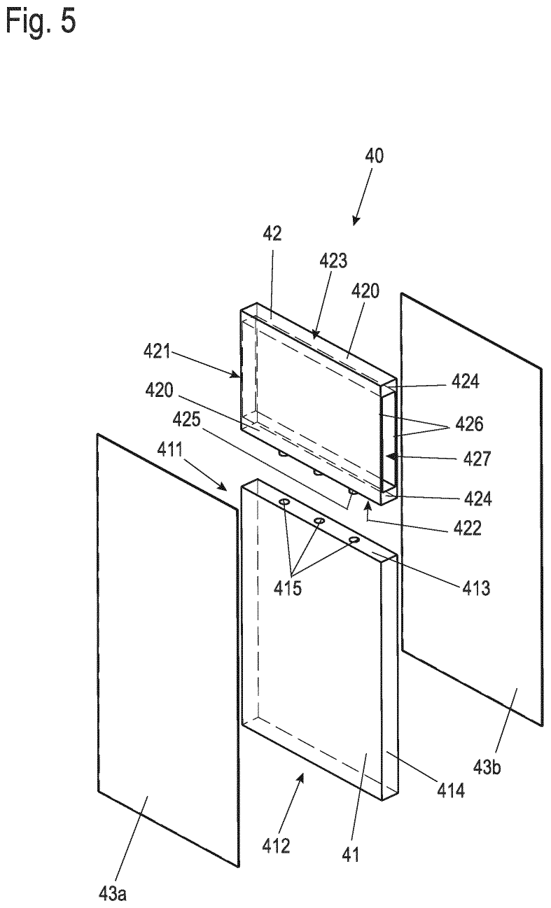

According to the application, the side walls 13 are composite elements, which are explained in more detail in connection with the FIGS. 5ff.

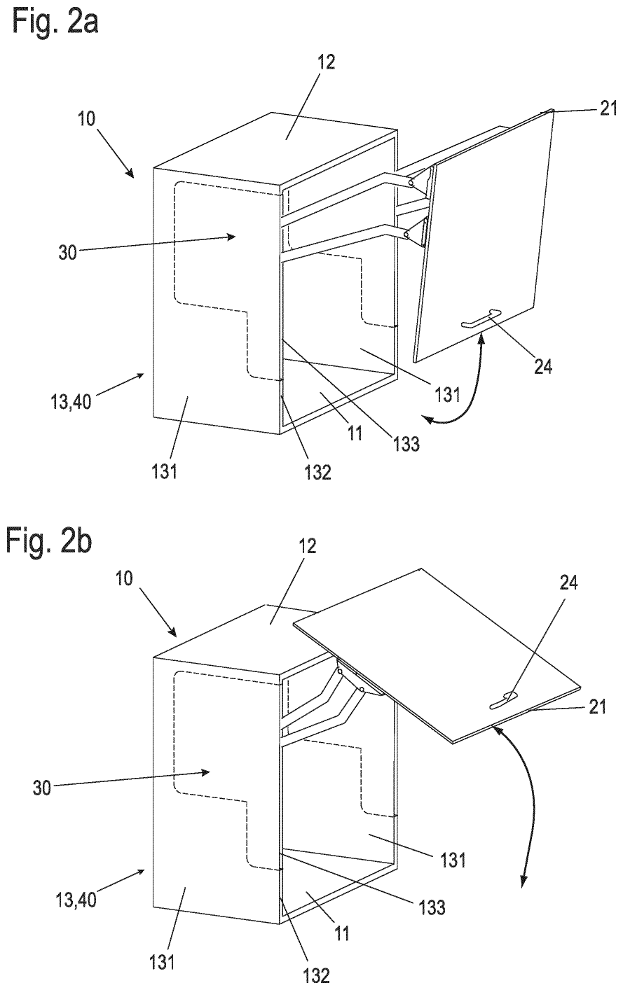

FIGS. 2a and 2b show another wall unit as an example of a piece of furniture with a side wall in accordance with the application, each in an isometric view.

As in the example in FIG. 1, an integral flap 21 is provided as flap arrangement 20 to close a furniture body 10 to the front. The two FIGS. 2a and 2b differ in the opening state of the flap arrangement 20. FIG. 2a shows a partially opened state of the flap arrangement 20, whereas FIG. 2b shows the maximum opening state of the flap arrangement 20. In contrast to the embodiment example in FIG. 1, a lifting and pivoting fitting is provided that enables a combined pivoting and displacing movement of the integral flap 21. In the fully open position shown in FIG. 2b, at least part of flap 21 is positioned above top panel 12 of furniture body 10. In this way, good access to the interior of furniture body 10 is achieved without the lower edge of flap 21, in the area of which a handle 24 is mounted, pivoting to the height of the top panel 12. In this way, even if the wall unit is mounted high in the room, the flap 21 is easily accessible in the open position so that it can be closed again.

As in the embodiment example of FIG. 1, the side walls 13 are designed as composite elements 40, which accommodate the fitting 30.

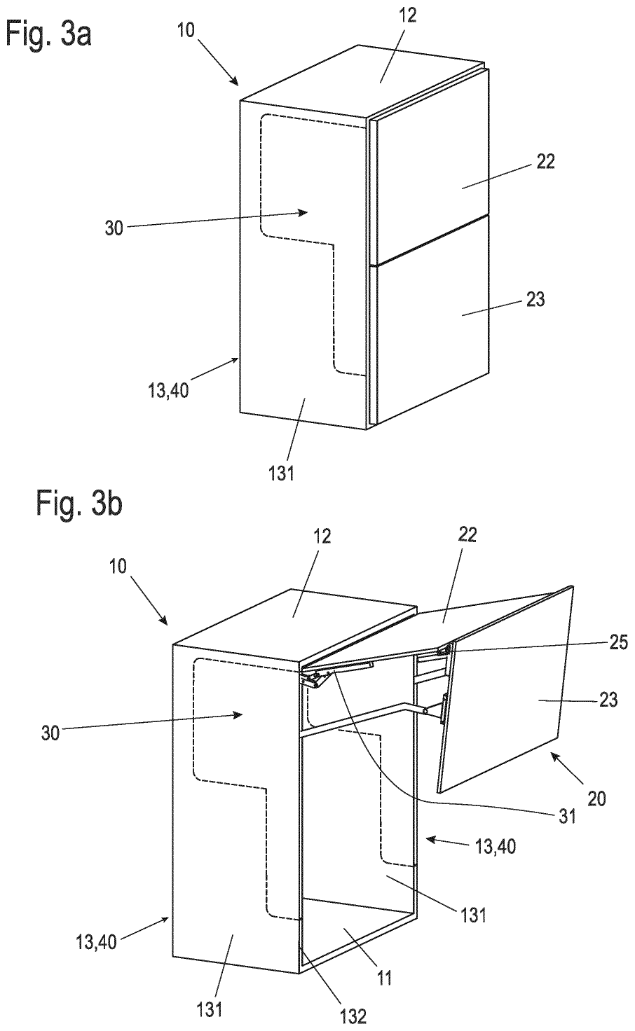

FIGS. 3a and 3b show another embodiment example of a wall unit with furniture body 10 and flap arrangement 20. FIG. 3a shows the flap arrangement 20 in a closed position and FIG. 3b in an open position.

This piece of furniture has a two-part flap arrangement 20 with an upper flap part 22 and a lower flap part 23. Again, the side walls 13 are designed as composite elements that accommodate a fitting 30. This is coupled with lever mechanisms 31 both with the upper flap part 22 and with the lower flap part 23. In addition, additional hinges 25 are provided, which pivotably connect the upper and lower flap parts 22, 23 to each other along their connecting line. Depending on the design of the flap fitting, the hinges can also be omitted.

As in the embodiment example for FIGS. 2a, 2b, good access to the interior of furniture body 10 is also achieved here without the flap arrangement 20 pivoting too far upwards in the open state for the user to reach.

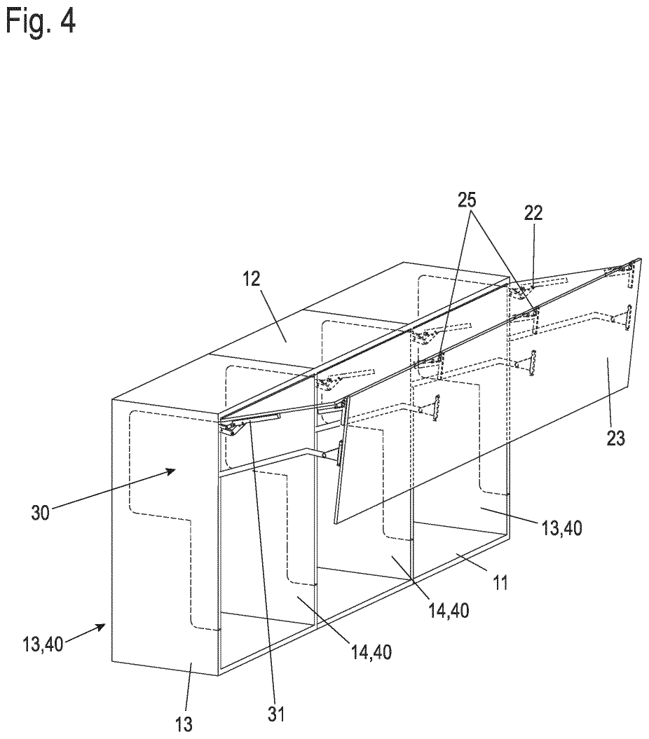

FIG. 4 shows another wall unit with furniture body 10 and flap arrangement 20, in which fittings 30 for guiding the flap arrangement 20 are arranged in composite elements 40. In the example shown, the furniture body 10 has an interior divided by vertical partition walls 14. Two partition walls 14 are provided in this case, which divide the interior into three sections. In this embodiment, each partition wall 14 is designed as a composite element 40. However, the arrangement shown can also be realized with only one partition wall or more than the illustrated two partition walls 14.

The flap arrangement 20 is comparable with the embodiment example of FIGS. 3a and 3b in two parts with an upper flap part 22 and a lower flap part 23. The flap arrangement 20 extends in its width, and also the upper and lower flap parts 22, 23, over the entire furniture body 10. In order to be able to guide the flap arrangement 20 smoothly, fittings 30 are also present in the intermediate walls 14. Both the side walls 13 and the partition walls 14 are designed as composite elements 40 in accordance with the application.

In all the embodiment examples shown, the composite elements are characterized by continuous side surfaces with a uniform surface look and feel across the entire surface. In particular, no transition in the area of the edge of the fitting 30 is discernible in the surface.

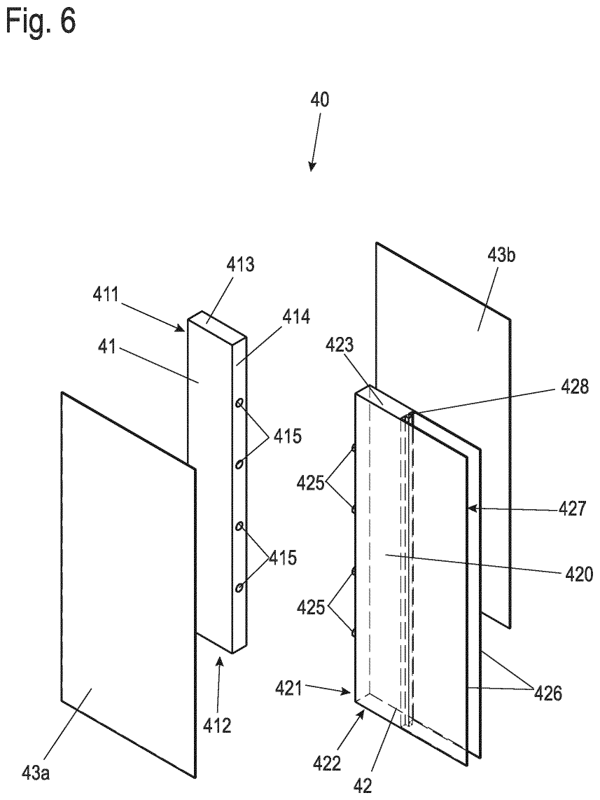

FIGS. 5 and 6 each show an embodiment example of a wall designed as a composite element 40 for a furniture body in an isometric exploded view. The walls shown can, for example, be used as side wall 13 in the embodiment examples of FIGS. 1-4 or also as a partition wall 14 in the embodiment example of FIG. 4. However, the wall designed as a composite element 40 is not limited to a vertical arrangement. Furniture body elements that are arranged horizontally, such as top, bottom and intermediate panels, or even diagonally arranged walls in the room, can also be designed according to this invention.

The composite element 40 has a core 41 in both cases, for example made of chipboard or a medium or high density fiberboard (MDF—Medium Density Fiberboard or HDF—High Density Fiberboard). The core 41 has a rectangular basic dimension, with a rear end face 411, a lower end face 412, an upper end face 413 and a front end face 414. The front end face 414 is the one which points in the direction of the opening of a furniture body, which can normally be closed by a door or flap or a thrust element, for example a drawer.

The terms rear, bottom, top and front refer to the orientation of the composite element 40 as the vertical side or partition wall of a furniture body shown in FIG. 5. It is understood that the composite element 40 shown can also be used in horizontal orientation. The upper and lower end faces 412, 413 then represent the left and right end faces respectively.

Furthermore, the wall has a housing 42, which also has a rectangular oversize and a thickness corresponding to that of the core 41. The housing 42 has a rear end face 421, a lower end face 422, an upper end face 423 and a front end face 424. In addition, the housing 42 has at least one support section 420 each, as well as side plates 426 connected thereto. Between at least sections of the side plates 426 there is an insertion compartment 427 for a fitting 30. The support sections 420 and also the side plates 426 can, for example, be made of aluminum. The support sections 420 and the side plates 426 can preferably be manufactured together in one continuous casting profile.

In the embodiment example of FIG. 5, the housing 42 is arranged above the core 41. The housing 42 has the same width as the core 41, i.e., it extends horizontally over the entire extension of the core 41 and thus also of the composite element 40. The housing 42 rests with its lower end face 422 on the upper end face 411 of the core 41. Core 41 and housing 42 are interconnected along these two end faces 411, 422. As connecting means, connecting pins 425 are provided on the housing 42, which are inserted into the correspondingly positioned bores 415 in the core 41. In addition, an adhesive can be used along the end faces 411, 422 and in the area of the connecting pins 425 or holes 415 to connect the two elements. As an alternative to the combination of connecting pins 425 and bores 415, a tongue-and-groove connection can also be provided between the housing 42 and the core 41.

The housing 42 shown in FIG. 5 has two support sections 420, which are rod-shaped and form the lower or upper region of the housing 42 and correspondingly provide the lower or upper end face 422, 423.

These support sections 420 can be, for example, aluminum profiles, wherein the connecting pins 425 are either inserted into the corresponding holes in the lower solid element 420 or are formed on this profile. The support sections 420 can also be made of plastic or wood in alternative embodiments. The side plates 426 are connected to the support sections 420 or are formed together with them integrally to form the housing 42. The side plates 426 can also be made of aluminum or plastic. The fitting 42 is open at the front between the two side plates 426, whereas in the rear area a cover or plug can be inserted which forms the rear end face 421. If necessary, when such a cover or plug is used, the rear section of the composite element 40 can also be cut to length and the opening can be closed again with the cover or plug to produce a less deep body. It is understood that the composite element 40 can of course also be shortened in its lower section if required.

Cover layers 43a, 43b are applied to the arrangement of core 41 and the associated housing 42 from each side, in particular glued or laminated thereon. The housing 42 and in particular the side plates 426 have been selected with regard to their material and material thickness so that even during a lamination process the housing 42 is not pressed in, which would lead to an unevenness of the surface of the cover layers 43a, 43b and could also narrow the formed insertion compartment 427 between the side plates 426, which could make a later insertion of a fitting more difficult or could lead to the fitting becoming inoperative or stiff due to mechanical stresses.

As an alternative to retrofitting a fitting into the insertion compartment 427, it is also possible that the housing 42 contains the fitting with its functional parts before the composite element 40 is completed. The functional parts of the fitting are then arranged, for example, on a support section 420 or a side plate 426.

Finally, edge bands can be applied to refine the visible end faces of the composite element 40.

With regard to the basic construction, the second embodiment example of the composite element shown in FIG. 6 is comparable to the one shown in FIG. 5. The same reference signs indicate the same or equivalent elements as in FIG. 5.

In contrast to the example in FIG. 5, the core 41 and the housing 42 are connected to each other along a vertical plane. In this example, the housing 42 has a support section 420 extending over the entire height of the core 41 and thus of the composite element 40. Connecting pins 425 are formed on the rear end face 421 of the housing 42, which are inserted into corresponding bores 415, which are introduced into the core 41 from the front end face 414.

A front surface of the support section 420 is profiled and has an insertion profile 428. An inserted fitting 30 can engage in this insertion profile 428 in order to be fixed in the housing 42. For this purpose, the insertion profile 428 preferably has undercut edges. It can be, for example, a trapezoidal profile or a fir tree profile.

With the composite element 40 shown in FIG. 5, the height of the insertion compartment 427 is approx. 10 to 15 cm. In the example of FIG. 6 the insertion compartment 427 extends over the entire height of the composite element 40 and can therefore be up to 90 cm long. The thickness of the composite elements 40 is preferably in the range of 16 to 22 mm for a typical body, e.g. of a kitchen unit. The insertion compartment 427 is slightly less wide, specifically it is narrower by the sum of the thickness of the two cover layers 43a, 43b and the two side plates 426 of the housing 42. The thickness of the cover layers 43a, 43b is preferably in the range from less than one millimeter to 3 mm and that of the two side plates 426 is typically in the range from 1 to 2 mm.

In the embodiment examples shown in FIG. 5 and FIG. 6, the core 41 and the housing 42 are located along a horizontal or a vertical plane. These are preferred embodiments for reasons of ease of manufacture.

Alternatively, it is also possible to design the core 41 and the housing 42 in such a way that there is more than one connection level, for example a horizontal and a vertical connection. The housing 42 is shorter than the core 41 in at least two spatial directions. The connecting elements are then designed in such a way that they can be connected at both connection levels, e.g., a positive tongue-and-groove connection at one connection level can be combined with connecting pins at the other connection level.

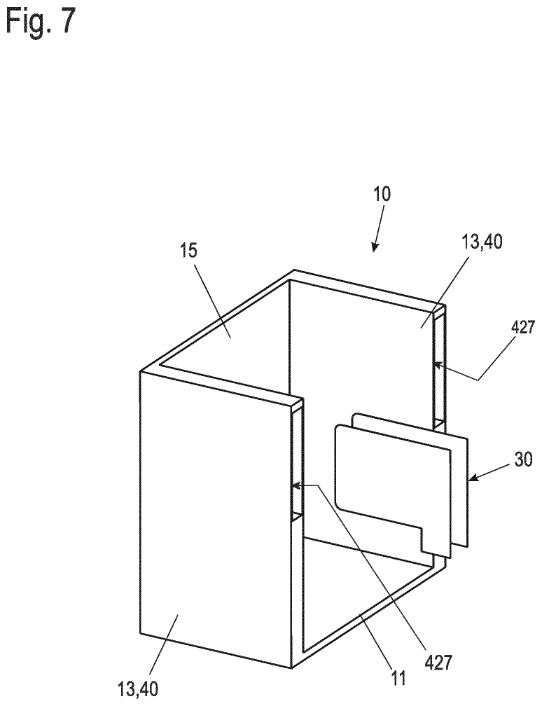

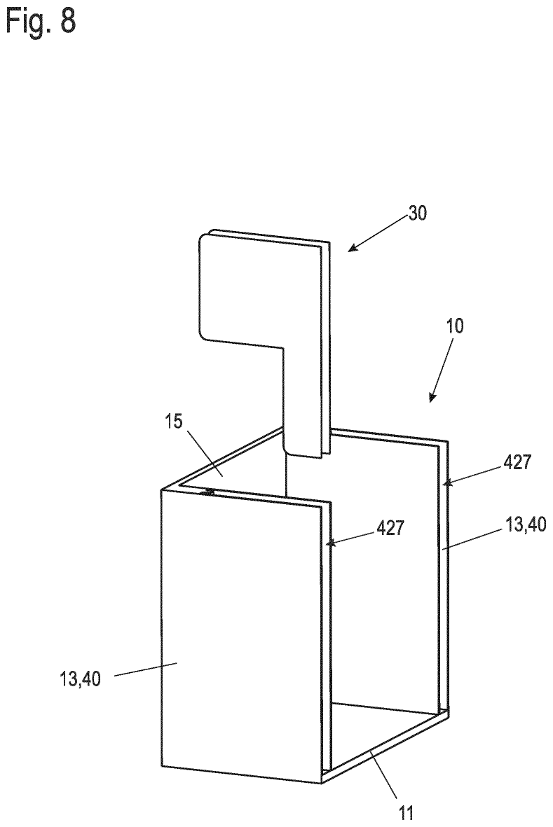

FIGS. 7 and 8 each show an isometric representation of a partially manufactured furniture body 10 with side walls 13, which are designed as composite elements 40 in accordance with FIGS. 5 and 6. The furniture bodies 10 also have a bottom panel 11 and a rear wall 15. A top panel is not shown for reasons of clarity.

In both figures, a fitting 30 to be inserted is shown schematically. A lever mechanism (see lever mechanism 31 in FIGS. 1-4) is also not shown for reasons of clarity.

In the embodiment example of FIG. 7, which uses composite elements 40 as side walls 13 according to FIG. 5, the fitting 30 is inserted into the furniture body 10 from the front. Fastening means, e.g., latching means, can be arranged in the housing 42 of the composite element 40 to hold the fitting 30 irreversibly or also detachably in the composite element 40.

In the embodiment example of FIG. 8, which uses composite elements 40 according to FIG. 6 as side walls 13, the fitting 30 is inserted from above into the housing 42, wherein a rear area of the fitting 30 engages in the insertion profile 428, whereby the fitting 30 is held in the housing 42 of the composite element 40.

Alternatively, or additionally, in both of the embodiment examples shown, the fitting 30 and/or an inner surface of the side plates 426 of the housing 42 can be provided with an adhesive layer in order to fix the fitting 30 exclusively or additionally.

Furthermore, claws can be arranged inside the fitting 30, which are coupled with an adjustment mechanism in order to be able to extend them laterally, whereby the fitting 30 is fastened inside the housing. The adjustment mechanism can, for example, be operated using a tool inserted into the fitting from the front, e.g., a screwdriver.

Further fittings such as cabinet hangers or connecting elements for e.g., interior organization or connecting interfaces for furniture body 10 can be integrated into the composite element 40. Electrical cables and other electrical components can also be integrated in the composite element for electrification of the composite element 40. The integration of lighting equipment such as LED luminaires is also possible.

The embodiment examples relate to pieces of furniture in which the doors or flaps are guided by fittings that are largely integrated into vertically arranged side walls or partition walls of the furniture. However, the wall according to the invention expressly also includes horizontally arranged walls, which are usually referred to as floor, top panel, bottom panel, intermediate bottom, etc.

For example, a hinge for a revolving door can also be integrated in the top panel, and a second hinge can be integrated in the associated bottom panel of the furniture to guide the door.

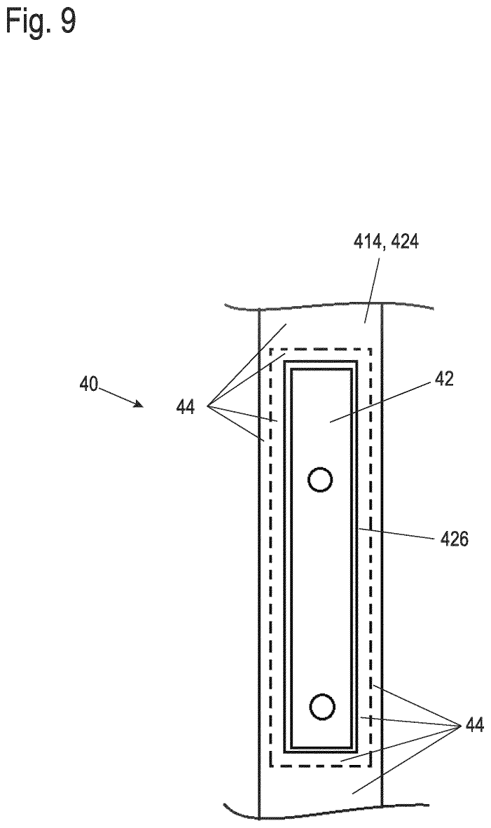

FIG. 9 shows a top view of a section of a composite element 40 in the area of an integrated housing 42 with a view to the front end faces 414, 424 of a core 41 and the housing 42. In this embodiment example, an edge band 44 is applied as a narrow-side coating to the front end faces 414, 424 of the core 41 or the housing 42 and thus of the composite element 40. Further edge bands (not visible here) can be applied in the area of the upper or lower end faces 412, 423 or the rear end face 411.

In the area of the opening of the housing 42, into which a fitting 30 can be inserted, the edge band 44 is recessed. The edge band 44 is applied to the front end faces 414, 424 after integration of the housing 42 into the composite element 40 or, optionally, only after insertion of the fitting 30 into the composite element 40.

The edge band 44 is cut out so that it rests in sections on the housing 42 and covers the edges of the side plates 426 of the housing 42, for example. In FIG. 9 the outlines of the housing 42 are indicated by dashed lines. Due to the arrangement of the edge band 44 also on sections of the housing 42, this is not visibly integrated in the composite element 40.

If the edge band 44 is also applied to parts, for example side plates of fitting 30, this is also completely integrated into the composite element 40—with the exception of the extendable lever mechanism 31—and no longer visible at the front end face of the composite element 40.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

10 Furniture body
11 Bottom panel
12 Top panel
13 Side wall
131 Side surface
132 End face
133 Opening in front face
14 Partition wall
15 Rear wall
20 Flap arrangement
21 Integral flap
22 Upper flap part
23 Lower flap part
24 Handle
25 Hinge
30 Fitting
31 Lever mechanism
40 Composite element
41 Core
411 Rear end face
412 Lower end face
413 Upper end face
414 Front end face
415 Bore
42 Housing
420 Support section
421 Rear end face
422 Lower end face
423 Upper end face
424 Front end face
425 Connecting pin
426 Side plate
427 Insertion compartment
428 Insertion profile
43a, 43b Cover layer
44 Edge band

1-26. (canceled)

27. A wall for a furniture body, the wall comprising:
a core; and
a housing arranged beside the core, wherein the housing is open towards at least one end face of the wall and the housing is used to accommodate a fitting that guides a movable furniture part,
wherein the core and the housing are covered by a continuous cover layer on at least one side surface of the wall, and
wherein the core and the housing rest against one another at a respective end face that extends over at least part of an extension of the wall.

28. The wall of claim 27, wherein the core and the housing are covered on both side surfaces by a continuous cover layer.

29. The wall of claim 27, wherein the core and the housing are connected to one another at adjoining end faces.

30. The wall of claim 29, wherein the core and housing are connected by at least one connecting means engaging in at least one corresponding receptacle.

31. The wall of claim 30, wherein the at least one connecting means and the at least one receptacle form a tongue-and-groove joint.

32. The wall of claim 30, wherein the connecting means are connecting pins and the receptacles are bores.

33. The wall of claim 32, wherein the connecting pins are integrally formed on the housing and the bores are formed in the core.

34. The wall of claim 27, wherein the core and/or the housing are glued to the continuous cover layer.

35. The wall of claim 27, wherein the fitting is already arranged in the housing before the core is rested against the housing.

36. The wall of claim 27, wherein the housing comprises connecting elements for securing an inserted fitting in the housing.

37. The wall of claim 36, wherein the connecting elements comprise an insertion profile.

38. The wall of claim 37, wherein the connecting elements comprise latching means.

39. The wall of claim 27, wherein the housing has side plates resting against the continuous cover layer.

40. The wall of claim 39, wherein the side plates are dimensionally stable so as to absorb lateral compressive forces.

41. The wall of claim 39, wherein the side plates are spaced at a distance corresponding to a thickness of the core.

42. The wall of claim 35, wherein the fitting has a lever mechanism configured to guide the movable furniture part.

43. The wall of claim 42, wherein the lever mechanism is located between the continuous cover layer in a closed state of the movable furniture part.

44. The wall of claim 34, wherein the fitting has additional stabilizing elements to absorb lateral compressive forces.

45. The wall of claim 27, wherein at least one of the end faces of the core includes an edge band.

46. The wall of claim 45, wherein the edge band is arranged at least in sections on the housing.

47. A method for manufacturing a wall for a furniture body, the method comprising:
providing a panel-shaped core and a housing for accommodating a fitting or a housing with a fitting arranged therein;
connecting the core and a housing each along one of their end faces;
applying two lateral cover layers to the connected core and housing.

48. The method of claim 47, wherein a fitting is inserted into the housing or is already arranged in the housing before the two lateral cover layers are applied.

49. The method of claim 47, wherein a fitting is inserted into the housing after the cover layers have been applied.

50. A piece of furniture or furniture body, comprising:
a wall, comprising
a core; and
a housing arranged beside the core, wherein the housing is open towards at least one end face of the wall and the housing is used to accommodate a fitting that guides a movable furniture part,
wherein the core and the housing are covered by a continuous cover layer on at least one side surface of the wall, and
wherein the core and the housing rest against one another at a respective end face that extends over at least part of an extension of the wall.

51. The piece of furniture or furniture body of claim 50, wherein the wall is a side wall or a partition wall with the housing and a flap fitting or a door fitting is inserted into the housing as a fitting.
